(19) United States
(12) Patent Application Publication
(10) Pub. No.: US 2017/0160624 A1
(43) Pub. Date: Jun. 8, 2017

(54) Fully Articulated Camera Mount

(71) Applicant: Thomas Craig Boushell, Hellertown, PA (US)

(72) Inventor: Thomas Craig Boushell, Hellertown, PA (US)

(21) Appl. No.: 15/214,697

(22) Filed: Jul. 20, 2016

Related U.S. Application Data
(60) Provisional application No. 62/263,275, filed on Dec. 4, 2015.

(51) Int. Cl. G03B 17/56; F16M 13/02

(52) U.S. Cl. CPC G03B 17/561; F16M 13/022; F16M 11/12

(57) ABSTRACT

A fully articulated camera mount is presented that may be attached to a tree (or pole or other vertical object) and used by an individual to record activities, such as hunting, without the tree itself being an impediment to the view. The camera mount is configured to include an articulated arm connected between a mounting bracket (used for attachment to a tree) and a camera support fixture. The articulated arm is formed of several telescoping members that can be readily adjusted to provide the horizontal and vertical spacings desired by the user. The arm is attached to the mounting bracket via a pivoting connector, allowing for rotational movement of the arm to be provided. The support fixture is preferably also adjustable.

### CROSS-REFERENCE TO RELATED APPLICATIONS

This application claims the benefit of U.S. Provisional Application Ser. No. 62/263,275, filed Dec. 4, 2015 and herein incorporated by reference.

### TECHNICAL FIELD

The present invention relates to a camera mount and, more particularly, to a fully articulated camera mount that may be attached to a tree and used by an individual to record activities, such as hunting, without the tree itself being an impediment to the view.

### BACKGROUND OF THE INVENTION

In the sport of hunting, there are many situations in which it is useful to mount cameras in natural settings in positions to observe and record encounters with the hunted animals. During hunting trips, hunters often wish to either monitor a trail frequented by the animals being hunted, or make a video recording of the actual kill of the animal. In such situations, it is desirable to be able to mount a camera (i.e., a camcorder) to a nearby tree. While there are various types of camera mounts for this purpose, many of them are only able to hold the mounted camera in a fixed position (and may also require that the mount be attached to the tree with a bore). While other mounts may utilize a bracket/brace that surrounds the tree in a quickly removable manner, these mounts also hold the camera in a fixed position.

There is known to be a type of camera mount that combines an archery bow holder (which includes telescoping arms) with a standard commercial camera mount. While this configuration offers the ability for the hunter to move the location of the camera to a degree, the range of motion is limited and there are times when the tree itself blocks the viewing angle.

### SUMMARY OF THE INVENTION

The needs remaining in the prior art are addressed by the present invention, which relates to camera mount and, more particularly, to a fully articulated camera mount that may be attached to a tree and used by an individual to record activities, such as hunting, without the tree itself being an impediment to the view.

In accordance with the present invention, a camera mount is configured to include an articulated arm connected between a mounting bracket (attached to a tree or other vertical object) and a camera support fixture (where a smartphone, video recorder, or any other type of device may be attached to the support fixture). The articulated arm is formed of several telescoping members that can be readily adjusted to provide the horizontal and vertical spacings desired by the user. The arm is attached to the mounting bracket via a pivoting connector, allowing for rotational movement of the arm to be provided. The support fixture is preferably also adjustable.

In one embodiment of the present invention, a first set of telescoping arm segments are adjustable to create the desired horizontal spacing, and a second set of telescoping arm segments are adjustable to create the desired vertical spacing. Locking knobs, spring-loaded buttons, or any other suitable component, may be used to maintain the telescoping arm segments in the desired position.

A specific embodiment of the present invention takes the form of a camera mount including an articulated arm configured to provide adjustable horizontal, vertical, and rotational movement, a mounting bracket attached to a first end termination of the articulated arm, the mounted bracket configured for releasable attachment to a vertical object and a camera support fixture attached to a second, opposing end termination of the articulated arm.

Other and further advantages and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates an exemplary articulated arm camera mount formed in accordance with the present invention;

FIG, 2 is an exploded view of the articulated arm camera mount, as shown in FIG. 1;

FIG. 3 is an enlarged view of the mounting bracket portion of the articulated arm camera mount as shown in FIGS. 1 and 2; and

FIG. 4 illustrates another embodiment of the present invention.

### DETAILED DESCRIPTION

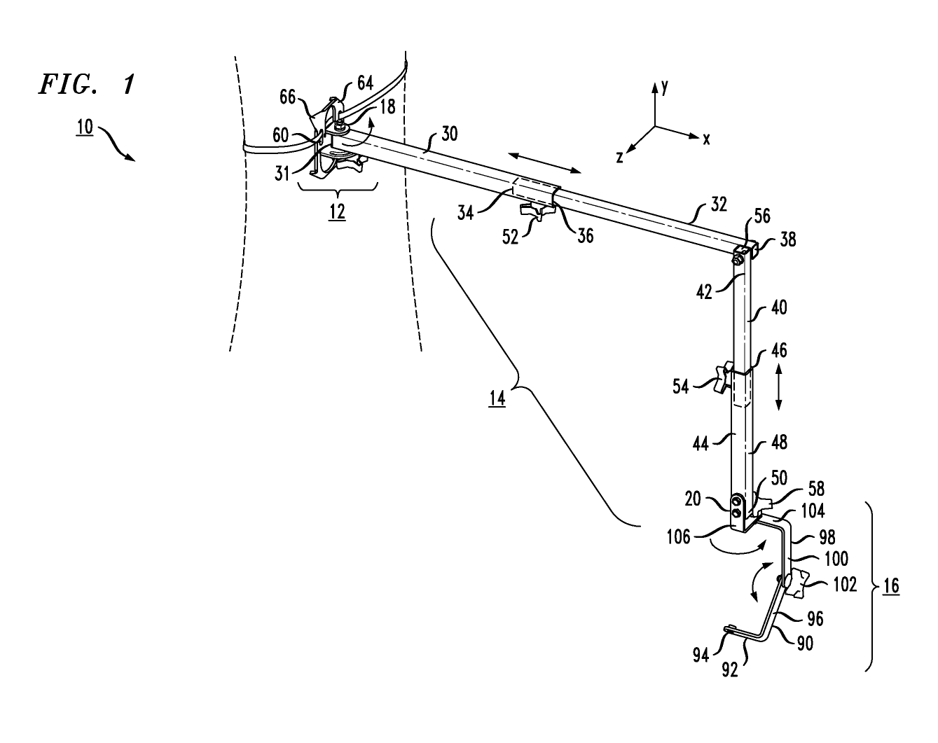

FIG. 1 illustrates an exemplary articulated camera mount 10 formed in accordance with the present invention. Camera mount 10 comprises three main components: a mounting bracket 12, an articulated arm 14 and a camera support fixture 16. As shown, articulated arm 14 connects to mounting bracket 12 at a first termination 18, and connects to camera support fixture at a second, opposing termination 20. In use, mounting bracket 12 is removably attached to a vertical object (such as, for example, a tree, fence post, pole, or the like) and, a user's camera is attached to support, fixture 16. Various types of well-known configurations for providing both of these attachments may be employed, with examples being discussed in detail below. In accordance with the present invention, the utilization of a fully articulated arm (that is, a arm that is capable of adjusting its horizontal positioning, vertical positioning and rotation positioning with respect to the “vertical object”) allows for the user to record pictures and video without any impediments in the desired field of view.

In accordance with the present invention, articulated arm 14 of camera mount 10 comprises a plurality of individual segments that enable the arm to provide these desired range of motions (horizontal, vertical, and rotational) and enable the camera to record in a manner that is not impeded by the presence of the vertical object (e.g., tree). In the exemplary embodiment shown in FIG. 1, articulated arm includes a first segment 30 which engages with mounting bracket 12. A second segment 32 is formed as a telescoping segment, with a first end termination 34 that is disposed within an open end 36 of first segment 30. An opposing second end termination 38 of segment 32 is shown as a closed-end surface. In accordance with this embodiment of the present invention, a third arm segment 40 is attached to second end termination 30 of arm segment 32 as shown in FIG. 1.

In this case, third arm segment 40 is also formed as a telescoping segment, with an opposing end termination 44 of third segment 40 inserted within an open end 46 of a fourth arm segment 48. A second, opposing end termination 50 of fourth arm segment 48 is shown in FIG. 1 as attached to camera support fixture 16.

In accordance with the present invention, the ability to control (and thereafter “fix”) the location of a camera during a live event by properly configuring the, articulated arm is a significant advantage over the prior art. In particular, the horizontal movement of camera mount 10 is provided by modifying the position of telescoping second arm segment 32 within first arm segment 30 (shown as the “x-axis” movement in FIG. 1). Once a desired positioning is achieved, a fixing member, in this case a knob 52, is used to hold and maintain this position. In a similar manner, the vertical positioning is adjusted by moving telescoping third arm segment 40 within fourth arm, segment 48. Again, a knob 54 is shown as being used to maintain the desired positioning. It is to be understood that various other mechanisms may be used in place of knobs 52, 54. For example, spring-loaded buttons may be used in combination with a set of apertures to create a set of defined adjustments.

Referring again to FIG. 1, a brace component 60 of mounting bracket 12 is connected to first arm segment 30, and is adjustable to allow for rotational movement of articulated arm 14 in the manner shown (i.e., rotating about the z-axis direction). Additionally, it is possible to adjust the angular connection between second arm segment 32 and third arm segment, which in the configuration shown in FIG. 1 may be accomplished by using a bolted attachment 56. Moreover, the angular position of camera support fixture 16 with respect to arm segment 48 may be adjusted by using (for example) a knob 58.

FIG. 2 is an exploded view of the configuration shown in FIG. 1. Clearly shown in this view is end termination 34 of second arm segment 32 (which telescopes back and forth within open end 36 of first arm segment 30). Similarly, end termination 44 of third arm segment 40 (which telescopes back and forth within open end 46 of fourth arm segment 48) is also clearly shown. Knobs 52, 54, and 58 are also shown, as is bolt 56.

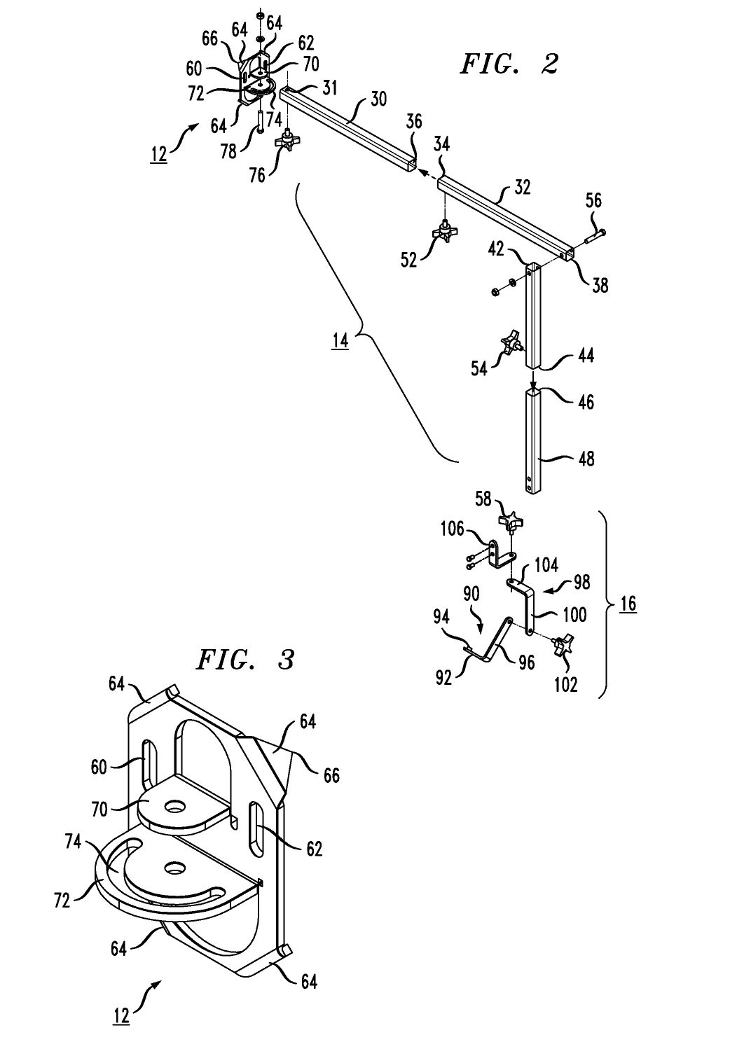

Additionally, FIG. 2 includes an exploded view of mounting bracket 12, with an enlarged view of bracket 12 shown in FIG. 3. Referring to both FIGS. 2 and 3, this particular embodiment of mounting bracket 12 is shown as including, a pair of apertures 60, 62. As mentioned above, mounting bracket 12 may be releasably attached to a vertical object (e.g., tree, pole, etc.) and a mounting strap, bungee cord, etc, may be inserted through apertures 60, 62 and placed around the vertical object to hold camera mount 10 in place. Also evident in the particular embodiment shown in FIGS. 2 and 3 is a set of corner angles 64, which may be used to re-enforce the attachment of camera mount 10 to objects such as tress or wooden poles/fence posts. As best seen in FIG. 3, each corner angle 64 includes a sharp, triangular termination point 66 that may be hammered or forced into the vertical object to further secure the attachment of camera mount 10

In accordance with this particular embodiment of the present invention, mounting bracket 12 is shown as further comprising a pair of parallel plates 70 and 72, oriented and spaced such that end termination 31 of first arm segment 30 securely fits between the plates (as shown in FIG. 1). Additionally, lower plate 72 is shown as including an arcuate slot 74, which is used in conjunction with a knob 76 to control the rotational positioning of articulated arm 14. In attaching first arm segment to mounting bracket 12, end termination 31 is positioned between plates 70 and 72. A pivot pin 78 is inserted through an aperture 80 in lower plate 72, where pivot pin 78 then passes through a pair of apertures (not shown) in arm segment 30, exiting through an aperture 82 formed in top plate 70. A locking nut 84 (or other fixture) is used to then hold pivot pin 78 in place, with articulated arm 14 thus attached to mounting bracket 12. In accordance with this embodiment of the present invention, the operation of knob 76 can be used to rotate arm segment 30 within arcuate slot 74, providing the desired orientation of articulated arm 14. Once the desired rotation is, achieved, knob 76 is tightened and arm 14 remains motionless (until the user desires to change the position).

It is to be understood that this particular configuration of mounting bracket 12, including the components used to provide pivoting for articulated arm 14, is exemplary only. Various other configurations of a mounting bracket and rotating attachment may be used and are considered to fall within the scope of the present invention.

Referring back to FIGS. 1 and 2, camera support fixture 16 is shown as including a first L-shaped support member 90 that is used for the attachment of any type of camera, phone, or other recording device. In this particular embodiment, lower arm 92 of first L-shaped support member 90 is formed to include a conventional mounting element 94 as typically used for attaching a camera or other device to a fixture. An upper arm 96 of first L-shaped support member 90 is shown in this particular embodiment as attached to a second L-shaped support member 98; in particular, upper arm 96 is attached to a first arm 100 via an adjustment knob 102. A second arm 104 of second L-shaped support member 98 is shown as attached to end termination 50 of arm segment 48 via a bracket 106. The use of a pair of L-shaped support members joined at knob 102 allows for the user to adjust the location of the device mounted on, lower arm 92 with respect to bracket 106. Additionally, the use of knob 58 allows for the orientation of camera support fixture 16 itself to be adjusted with respect to articulated arm 14.

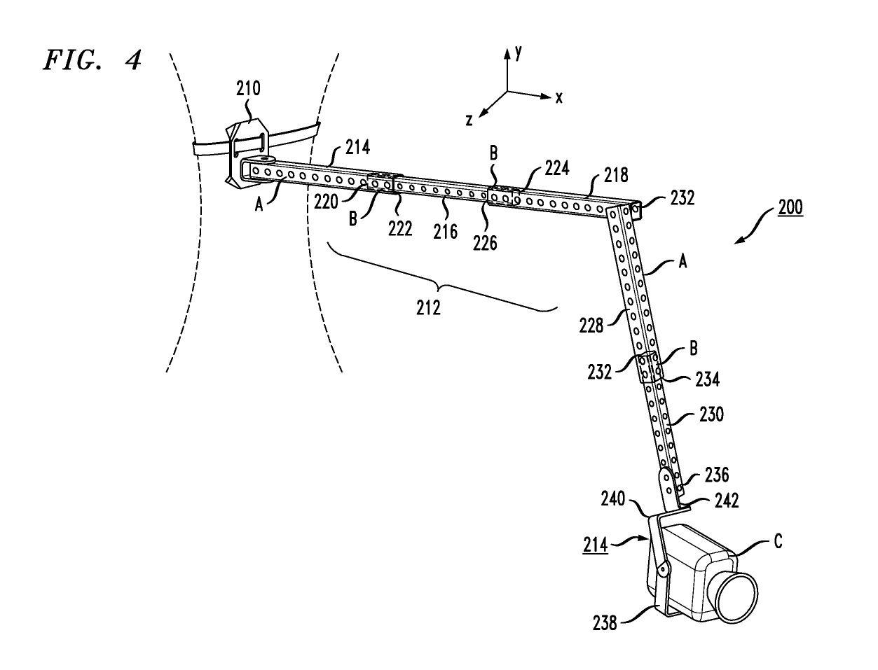

FIG. 4 illustrates an alternative embodiment of an articulated arm camera mount formed in accordance with the present invention. Similar to the embodiment described above, camera mount 200 as shown in FIG. 4 includes a mounting bracket 210, an articulated arm 212, and a camera support fixture 214. In this particular embodiment, the horizontal adjustment of the camera location with respect to the vertical object (shown in phantom) is provided by a three-piece horizontal arm portion, shown as including arm segments 214, 216, and 218. Also a telescoping configuration for providing adjustments, this particular embodiment configures arm segment 216 as a telescoping member that fits within both arm segments 214 and 218. In particular, and as shown in FIG. 4, a first end termination 220 of telescoping segment 216 is disposed within an open end termination 222 of arm segment 214. Similarly, a second end termination 224 of telescoping segment 216 is disposed within an open end termination 226 of arm segment 218.

As shown in FIG. 4, this particular embodiment utilizes a series of apertures A formed along the arm segments and spring-loaded buttons B (disposed within the telescoping segments) to provide the adjustment. This is one alternative to the use of knobs, as shown in FIGS. 1-3. Indeed, various other configurations for providing the telescoping adjustment necessary in the articulated arm of the present invention may be used and are considered to fall within the scope of the present invention.

Vertical adjustment in camera mount 200 is provided by a pair of telescoping arm segments 228 and 230. As shown, arm segment 228 is attached to an end termination 232 of arm segment 218. Arm segment 230 is formed as a telescoping segment, with a first end termination 232 disposed within an open end 234 of arm segment 228. A second, opposing end termination 236 of telescoping segment 230 is attached to camera support fixture 214, as shown.

In the particular embodiment shown in FIG. 4, a camera C is shown in position on camera mounting fixture 214. Fixture 214 is similar to the configuration deserted above, including a lower L-shaped support member 238 and an upper L-shaped support member 240, with camera C attached to lower support member 238 and upper support member 240 attached to articulated arm 212 via a support bracket 242.

It is to be understood that there are many variations and alternatives that may be used to form the different components of the present invention. Additionally, the specific materials used to form each component are considered to a design choice of the user. Thus, while the structure of this invention has been described in connection with specific embodiments, it should be understood clearly that these descriptions are only made by way of example and are not intended to limit the scope of the present invention.

What is claimed is:

1. A camera mount comprising:
an articulated arm configured to provide adjustable horizontal, vertical, and rotational movement;
a mounting bracket attached to a first end termination of the articulated arm, the mounted bracket configured for releasable attachment to a vertical object; and
a camera support fixture attached to a second, opposing end termination of the articulated arm.

2. The camera mount as defined in claim 1 wherein the articulated arm comprises a plurality of telescoping segments joined to create adjustable horizontal, vertical and rotational movement.

3. The camera mount as defined in claim 2 wherein the articulated arm comprises a first set of telescoping segments coupled together to provide for adjustable horizontal movement and a second set of telescoping segments coupled together to provide for adjustable vertical movement, the first set connected to the second set at opposing end terminations.

4. The camera mount as defined in claim 3 wherein a threaded knob component is used to maintain an adjusted position between the telescoping segments in at least one of the first and second sets of telescoping segments.

5. The camera mount as defined in claim 3 wherein a spring-loaded button and aperture combination is used to, maintain an adjusted position between the telescoping segments in at least one of the first and second sets of telescoping segments.

6. The camera mount as defined in claim 1 wherein the mounting bracket further comprises a pair of parallel plates disposed to engage with the first end termination of the articulated arm.

7. The camera mount as defined in claim 6 wherein the mount further comprises a rotational adjustment knob and a lower plate of the pair of parallel plates includes an arcuate slot, such that the adjustment knob passes through the arcuate slot and engages the first end termination of the articulated arm in a manner that creates adjustable rotational movement of the articulated arm.
